(19) United States
(12) Patent Application Publication
(10) Pub. No.: US 2009/0010143 A1
(43) Pub. Date: Jan. 8, 2009

(54) POWER CONTROL SYSTEM AND METHOD OF OPTICAL DISK DRIVE

(75) Inventors: Choa-ming Huang, Hsin-Chu City (TW); Yao-Iung Chuang, Taipei Hsien (TW)

Correspondence Address: MADSON & AUSTIN, 15 WEST SOUTH TEMPLE, SUITE 900, SALT LAKE CITY, UT, 84101, US

(73) Assignee: MEDIATEK Inc., Hsin-Chu (TW)

(21) Appl. No.: 11/774,348

(22) Filed: Jul. 6, 2007

(51) Int. Cl. G11B 7/00

(52) U.S. Cl. 369/116

(57) ABSTRACT

The present invention provides an over drive power control system and a method which are capable of generating an optimized output power of the optical disk drive under a variation of operational environment. According to this invention, a photo detecting unit detects current laser power and generates a power feedback signal. A low frequency power control unit generates a modified power control signal by using the power feedback signal and an original power control signal. A high frequency power control unit generates a modified high frequency control signal for controlling the laser power according to a predetermined relationship among original and modified low power control signals and an original high frequency control signal. A digital-to-analog converter receives the modified high frequency control signal then outputs a adjusted write power signal for adapting the laser power to environmental variation and thus maintaining laser power in a constant state.

### FIELD OF THE INVENTION

The present invention generally relates to a power control system and a method of same for controlling an optical disk drive, which are capable of generating an optimized output power of the optical disk drive under a variation of operational environment.

### BACKGROUND OF THE INVENTION

In power control of an optical disk drive during a high-speed recording procedure, a power waveform of single level often causes a bad formation of the pits (or marks) on a recordable disk. As a result, conventional optical disk drive introduces a power control of composite waveform for increasing the writing performance, such as an over-drive power control to a CD-R media or a multi-pulse power control to a CD-RW media.

The main power of the laser generated by a laser diode of the optical disk drive is controlled by a write power control unit, for example. The write power of the laser is detected by a photodetector and then sampled by a sample and hold device according to a main power sample hold pulse. The sampled write power signal is fed back to the write power control unit as a feedback power signal. Then the write power control unit can adjust the write power of the laser using the feedback power signal. The above operations are similar to the read power. However, for an over drive power or multipulse power signal of the laser, the sampled period is very short Hence, the sampled feedback signal will be incorrect if the sampling bandwidth of the laser power feedback signal is not sufficient to support such short sampled period power signals. Further, the laser power control will be inconstant or incorrect if a high-frequency noise is induced.

As mentioned, since the sampled period of the over-drive power signal or the multi-pulse power signal are much shorter than that of the writing pulse or reading pulse, a higher bandwidth of the feedback signal of laser power and power control circuit is required, especially in a high-speed recording condition. Consequently and undoubtedly, the higher bandwidth induces a higher cost.

Some conventional arts adopt an open DAC (Digital to Analog Converter) control instead of the APC methods of the over-drive power control or the multi-pulse power control. The open DAC control means to control the OD power or the multipulse power at a constant level. Nevertheless, the optimized write power cannot be achieved by the open DAC control when the characteristic of laser diode varies under variation of operation environment, such as operation temperature. Therefore, the recording performance of the optical disk drive by open DAC control will be degraded under a varied operation environment.

FIG. 1 illustrates a diagram of characteristic relationship lines of the reading DAC value relative to the read power at specific temperatures. Referring to the left line in FIG. 1, a first read power rPW1 is achieved while the reading DAC value is of a first reading DAC value rDAC1. Similarly, a second read power rPW2 is relative to a second reading DAC value rDAC2. The DAC value is related to a gain of the digital-to-analog converter. Basically, the read powers are directly proportional to the reading DAC values, i.e. the read powers are ascendant while the reading DAC values increase. It should be noted that the characteristic relationship of a writing DAC value relative to the write power is similar to which of the reading DAC value relative to the read power.

As shown, relationships of the DAC value relative to the laser power at different temperatures are different. It is obvious that the two characteristic relationship lines have different slopes under different temperatures, i.e. the relationship of the DAC value relative to laser power would be varied with the temperature variation. The optical disk drive can adjust the laser power by determining a proper DAC value in accordance with the different characteristic relationships which are stored in the memory.

The characteristic relationship of the DAC value relative to the laser power can be explained clearly by following equations with detailed explanation. Referring to FIG. 1 again, we can set two reference reading DAC values rDAC1 and rDAC2 under a specific temperature for obtaining two corresponding read power rPw1 and rPw2 respectively. Thus, the equation (1) is obtained to represent the characteristic relationship of DAC value relative to laser power.

$$\frac{Δ rDAC}{Δ rP} = \frac{rDAC 2 - rDAC 1}{rPw 2 - rPw 1} \qquad ( 1 )$$

wherein rDAC represents a reading DAC value of the digital to analog converter, ΔrDAC represents a reading DAC variation of the digital to analog converter, and ΔrP represents a read power variation of the laser emitting unit.

Then, we can derive the proper reading DAC value rDAC from equation (2).

$$rDAC = \frac{Δ rDAC}{Δ rP} \times rPw + rOffset \qquad ( 2 )$$

wherein rPw represents a current read power, rOffset represents a read power offset of the laser emitting unit.

Similarly, the writing DAC value can be derived from the equations (3) and (4).

$$\begin{matrix}\frac{Δ wDAC}{Δ wP} = \frac{wDAC 2 - wDAC 1}{wPw 2 - wPw 1} & ( 3 ) \\ wDAC = \frac{Δ wDAC}{Δ wp} \times wPw + wOffset & ( 4 )\end{matrix}$$

wherein wDAC1 and wDAC2 represent two reference reading DAC values with respect to two write power wPw1 and wPw2 respectively under a specific temperature, ΔwDAC represents a writing DAC variation of the digital to analog converter, ΔwP represents a write power variation of the laser emitting unit, wPw represents a current write power, wOffset represents a write power offsets of the laser emitting unit, wDAC represents a proper writing DAC value of the digital to analog converter.

Further, we can also obtain two output voltage signals VO1 and VO2 of a reading channel of the APC circuit, with respect to the read powers rPw1 and rPw2 respectively. Accordingly, the characteristic relationship of the output voltage signal relative to the read power can be explained by the equation (5).

$$\frac{Δ P}{Δ V} = \frac{rPw 2 - rPw 1}{VO 2 - VO 1} \qquad ( 5 )$$

wherein the value of ΔP/ΔV represents a variation parameter of output power to output voltage of the APC circuit under different temperatures.

We may assume that the output voltage signal of reading channel of the APC circuit is VRO1 at a specific temperature. The characteristic of laser power will be varied by the variation of environment temperatures due to a temperature-rising environment or the high heat capacities produced during the recording operation of the optical dick drive. Therefore, the output voltage signal of APC circuit will be changed to VRO2 in order to maintain a constant output of laser power. Accordingly, we can obtain the characteristic relationship of the variation of the read power due to the variation of temperatures by comprehending equation (5), shown as equation (6).

$$Δ Pr = ( VRO 2 - VRO 1 ) \times \frac{Δ P}{Δ V} \qquad ( 6 )$$

wherein ΔPr represents the variation of read power of the laser emitting unit under the temperature variation.

Although the varied temperatures can be detected by using a temperature sensor, the usage of the temperature sensor by aforementioned power control methods of laser power will increase the cost of the optical disk drive. Further, conventional control methods would be easily invited within incorrect sampling signals by using a high-speed APC circuit in a high-speed recording condition. Also, that will increase the manufacturing cost of the optical disk drive to raise the sampling rate of signals.

### SUMMARY OF THE INVENTION

According to the present invention, a power control system of an optical disk drive is provided to effectively and dynamically control over drive or multipulse power of the optical disk drive. The optical disk drive has a laser diode for generating laser of multiple power levels and a detecting unit for detecting laser powers to generate power feedback signals correspondingly. In the power control system, a first power control unit is used to control the read or write power of the laser. The first power control unit generates an original first power control signal to control the laser diode to emit laser with a predeteremined power level. The first power control unit receives a first power feedback signal from the defecting unit. The first power feedback signal corresponds to the power level of the laser generated corresponding to the original first power control signal. The first power control unit generates a modified first power control signal according to the original power feedback signal and a desired power level to control the laser diode to emit laser corresponding to the modified first power control signal. A second power control unit is used to control over drive power and/or a multipulse write power for the laser diode. The second power control unit receives the original and modified first power control signals from the first power control unit, and generates a modified second power control signal according to a predetermined ratio, the modified and original first power control signals, and an original second power control signal to control the laser diode to emit laser with a desired power level.

The present invention also provides a method for maintaining the output power of a laser diode of an optical disk drive to improve the recording performance of the optical disk drive. In addition to the laser diode, the optical disk drive has a detecting unit for detecting laser powers of the laser diode to generate power feedback signals correspondingly. The power control method comprises generating an original first power control signal to control the laser diode to emit laser; generating a first power feedback signal corresponding to the laser generated corresponding to the original first power control signal; generating a modified first power control signal according to the first power feedback signal and a desired power level to control the laser diode to emit laser corresponding to the modified first power control signal; and generating a modified second power control signal according to a predetermined ratio, the modified and original first power control signals, and an original second power control signal to control the laser diode to emit laser with a desired power level.

The advantages of the present invention include: (a) generating a compensating DAC signal to adjust the output power of the laser emitting of an optical disk drive, especially to adjust a write power of the laser emitting, for maintaining the write power in a constant state; (b) providing a high recording performance of the optical disk drive with a reduced cost by compensating the power variation due to the temperature variation without a high-speed APC circuit.

### BRIEF DESCRIPTION OF THE DRAWINGS

FIG. 1 shows a diagram of two characteristic relationship lines of the reading DAC value relative to different read powers at two specific temperatures.

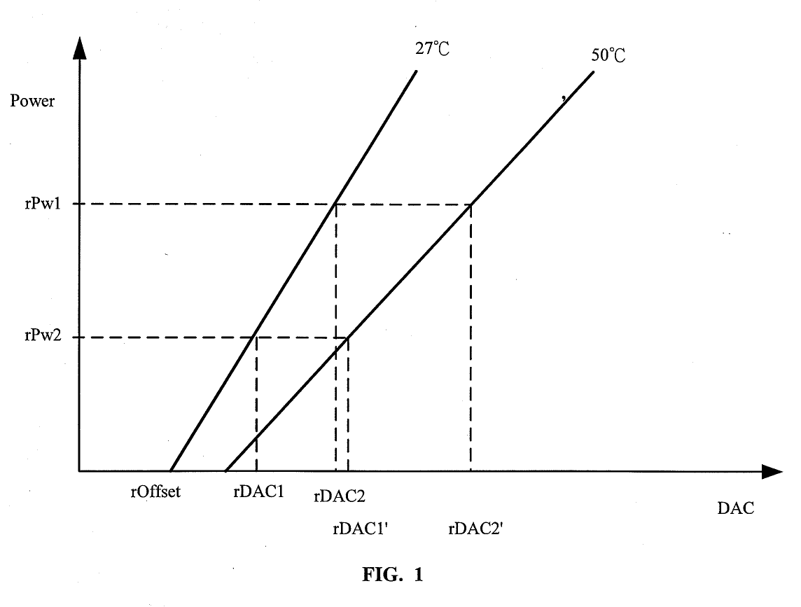

FIG. 2 illustrates a schematic diagram of a simplified structure of the optical disk drive in accordance with the present invention.

FIG. 3 illustrates a detailed embodiment of the present invention for exemplifying a method of getting a modified DACr value from the read power signal VRDCO and read power values.

FIG. 4 illustrates another detailed embodiment of the present invention for exemplifying a method of getting a modified DACw value from the write power signal VWDC1O and write power values.

FIG. 5 illustrates a further detailed embodiment of the present invention for exemplifying a method of getting a modified DACod value from the write power signal VWDC2O and write power values.

FIG. 6 illustrates a detailed embodiment of the present invention for exemplifying a method of calculating a new DACod value from the read power signal VRDCO and read power values.

FIG. 7 illustrates another detailed embodiment of the present invention for exemplifying a method of calculating a new DACod value from the write power signal VWDC1O and write power values.

### DETAILED DESCRIPTION OF THE PREFERRED EMBODIMENTS

By equation (6), we can introduce a characteristic index δ under different temperatures to calculate a compensating power ΔPwc for adjusting a write power of a writing channel of the APC circuit, shown as equation (7).

ΔPwc=δ×ΔPr (7)

Consequently, a compensating DAC value wDACc can be derived by introducing the equation (4) for compensating the output power of the laser emitting unit, shown as equation (8).

$$wDACc = \frac{Δ wDAC}{Δ wP} \times Δ Pwc \qquad ( 8 )$$

Finally, we can obtain the compensating DAC value by realizing the above-mentioned equations to generate a compensating power for maintaining the output power of the laser emitting unit in a constant level.

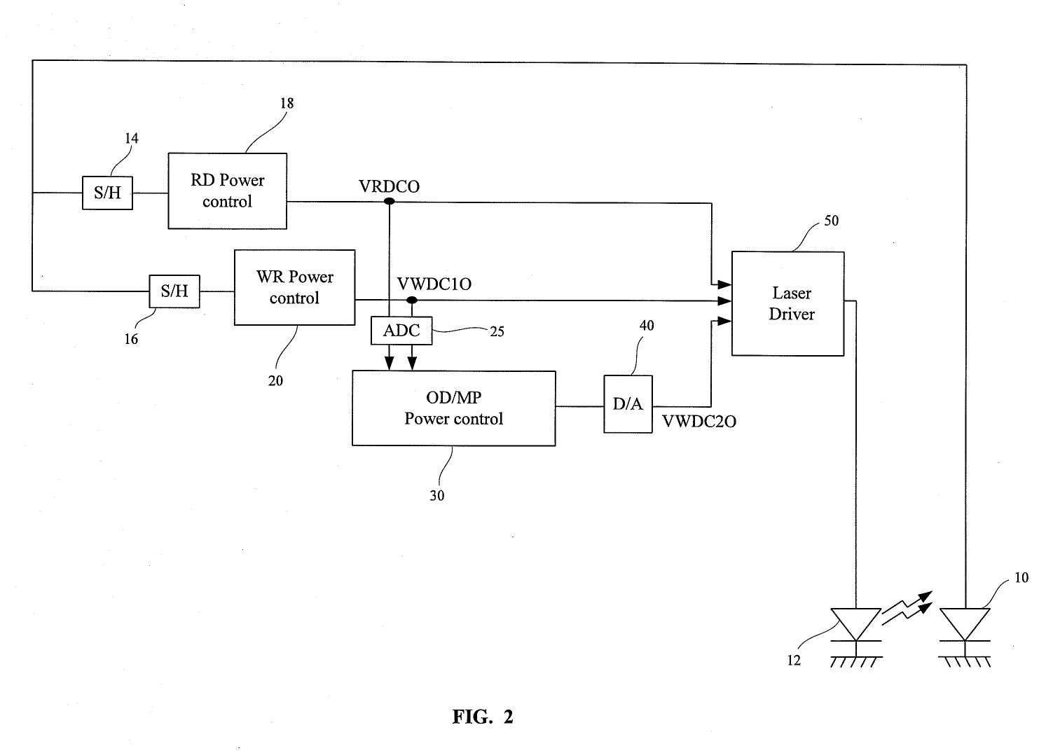

FIG. 2 shows a schematic diagram of a simplified structure of the optical disk drive in accordance with the present invention for generating an optimized laser power. The optical disk drive comprises a pickup-head comprising a photo detecting unit 10 and a laser emitting unit (e.g. a laser diode) 12, a sample and hold circuit 14 for read power signals, a sample and hold circuit 16 for write power signals, a read power control unit 18, a write power control unit 20, an analog-to-digital converter (ADC) 25, an advance power control unit 30, a digital-to-analog converter (DAC) 40, and a laser driver 50 for driving the laser emitting unit 12.

The photo detecting unit 10 detects current laser power of the laser diode and transmits the power feedback signals to the sample and hold circuits 14, 16. The sample and hold circuits 14, 16 sample the current read power feedback signal and current writing feedback power signal then transmit a sampled read power feedback signal and a sampled write power feedback signal to the read and write power control units 18, 20, respectively. The read and write power control units 18 and 20, each of which can be referred to as “a first power control unit”, generate and output a power control signal (VRDCO or VWDC1O as shown in FIG. 2) according to comparing the power feedback signals and a predetermined DAC value.

The power control signals VRDCO and VWDC1O are voltage values, which are converted into digital signals by the ADC 25 and transmitted to the OD/MP power control unit 30. The advance power control unit 30, which can also be referred to as a second power control unit, receives original and modified read or write power control signals (also referred to as first power control signals) from the ADC 25 and generates a modified (second) power control signal according to a predetermined relationship among the read or write power control signals and an original second power control signal so as to control the over drive power or multipulse write power of the laser diode.

The laser drive 50 receives the modified second power control signal, VWDC2O, which indicates a modified control value, to control the laser power. The laser driver 50 drives the laser emitting unit 12 by a proper power in accordance with the read power control signal VRDCO, write power control signal VWDC1O and OD/MP power control signal VWDC2O.

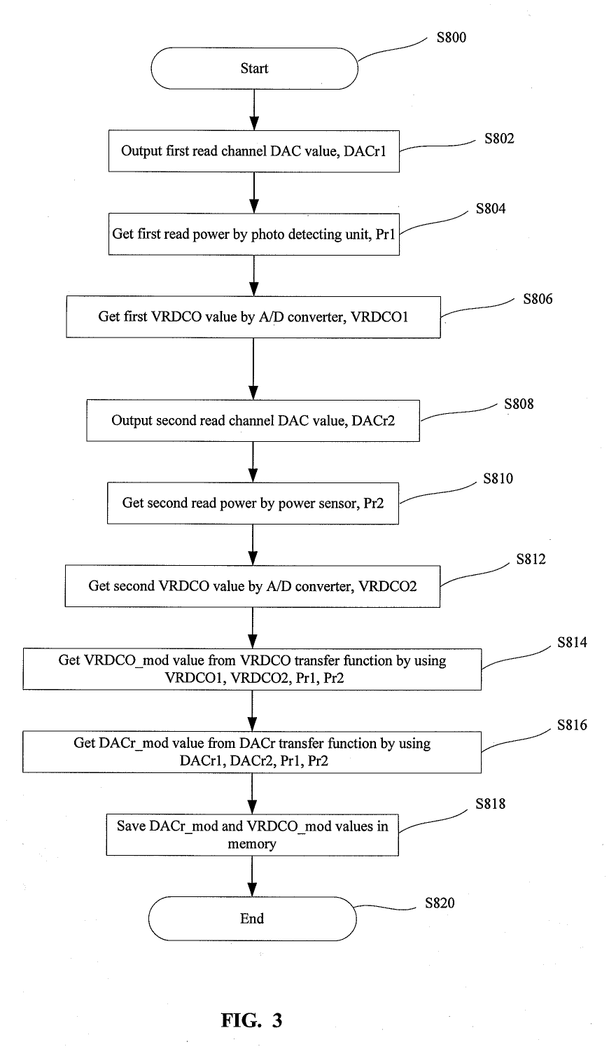

FIG. 3 illustrates a detailed embodiment of the present invention for exemplifying a method of getting a compensating DACr value from the read power control signal VRDCO and read power levels. The DACr value is used to generate the read power of the optical disk drive. The method of getting the DACr value comprises the steps of:
Step S800 Start;
Step S802 The read power control unit 18 sets a read channel DAC value DACr1;
Step S804 The photo detecting unit gets a first read power Pr1;
Step S806 The read power control unit 18 generates a first VRDCO value VRDCO1;
Step S808 The laser emitting unit outputs a second read channel DAC value DACr2;
Step S810 The photo detecting unit gets a second read power Pr2;
Step S812 The analog to digital converter gets a second VRDCO value VRDCO2;
Step S814 Calculating a new VRDCO value VRDCO_md from the VRDCO transfer function by using VRDCO1, VRDCO2, Pr1 and Pr2 values;
Step S816 Calculating a new DACr value DACr_md from the DACr transfer function by using DACr1, DACr2, Pr1 and Pr2 values;
Step S818 Saving the new DACr value DACr_md and new VRDCO value VRDCO_md in a memory;
Step S820 End.

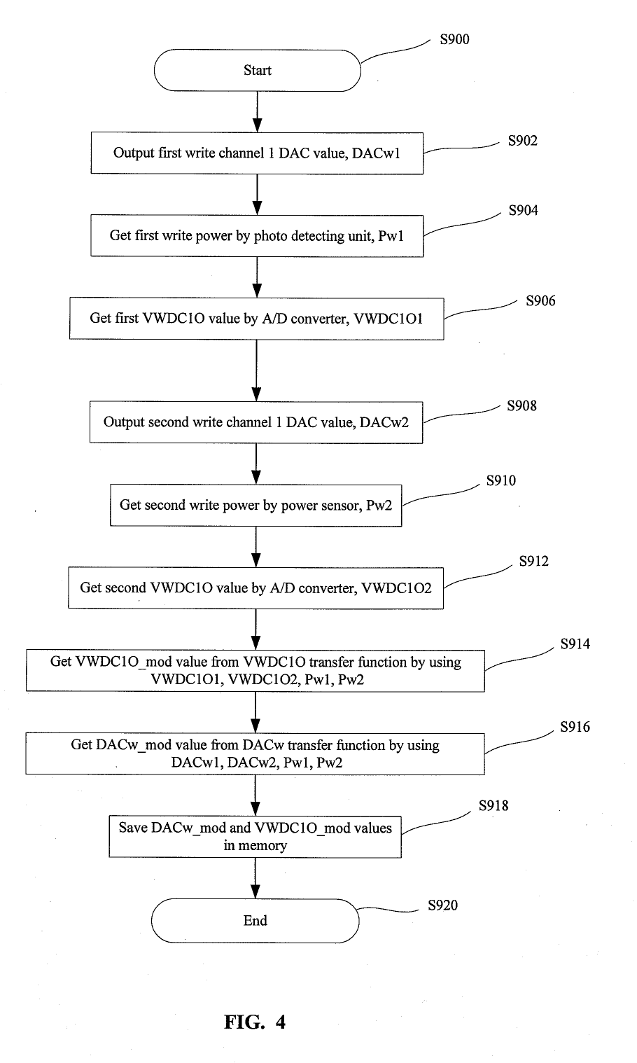

FIG. 4 illustrates another detailed embodiment of the present invention for exemplifying a method of getting a modified DACw value from the write power signal VWDC1O and write power values. The DACw value is used to adjust the write power of the optical disk drive. The method of getting the DACw value comprises the steps of:
Step S900 Start;
Step S902 The laser emitting unit outputs a first write channel DAC value DACw1;
Step S904 The photo detecting unit gets a first write power Pw1;
Step S906 The analog to digital converter gets a first VWDC1O value VWDC1O1;
Step S908 The laser emitting unit outputs a second write channel DAC value DACw2;
Step S910 The photo detecting unit gets a second write power Pw2;
Step S912 The analog to digital converter gets a second VWDC1O value VWDC1O2;
Step S914 Calculating a new VWDC1O value VWDC1O_md from the VWDC1O transfer function by using VWDC1O1, VWDC1O2, Pw1 and Pw2 values;
Step S916 Calculating a new DACw value DACw_md from the DACw transfer function by using DACw1, DACw2, Pw1 and Pw2 values;
Step S918 Saving the new DACw value DACw_md and new VWDC1O value VWDC1O_md in a memory;
Step S920 End.

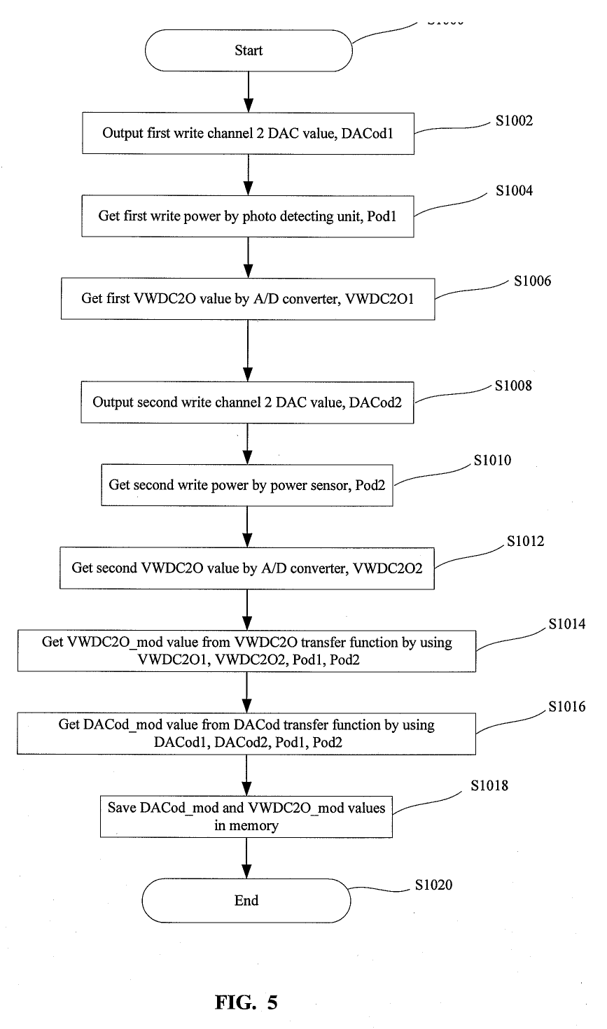

FIG. 5 illustrates a further detailed embodiment of the present invention for exemplifying a method of getting a modified DACod value from the write power signal VWDC2O and write power values. The DACod value is used to adjust the over-drive write power of the optical disk drive. The method of getting the DACod value comprises the steps of:
Step S1000 Start;
Step S1002 The laser emitting unit outputs a first write channel DACod value DACod1;
Step S1004 The photo detecting unit gets a first write power Pod1;
Step S1006 The analog to digital converter gets a first VWDC2O value VWDC2O1;
Step S1008 The laser emitting unit outputs a second write channel DACod value DACod2;
Step S1010 The photo detecting unit gets a second write power Pod2;
Step S1012 The analog to digital converter gets a second VWDC2O value VWDC2O2;
Step S1014 Calculating a new VWDC2O value VWDC2O_md from the VWDC2O transfer function by using VWDC2O1, VWDC2O2, Pod1 and Pod2 values;
Step S1016 Calculating a new DACod value DACod_md from the DACod transfer function by using DACod1, DACod2, Pod1 and Pod2 values;
Step S1018 Saving the new DACod value DACod_md and new VWDC2O value VWDC2O_md in a memory;
Step S1020 End.

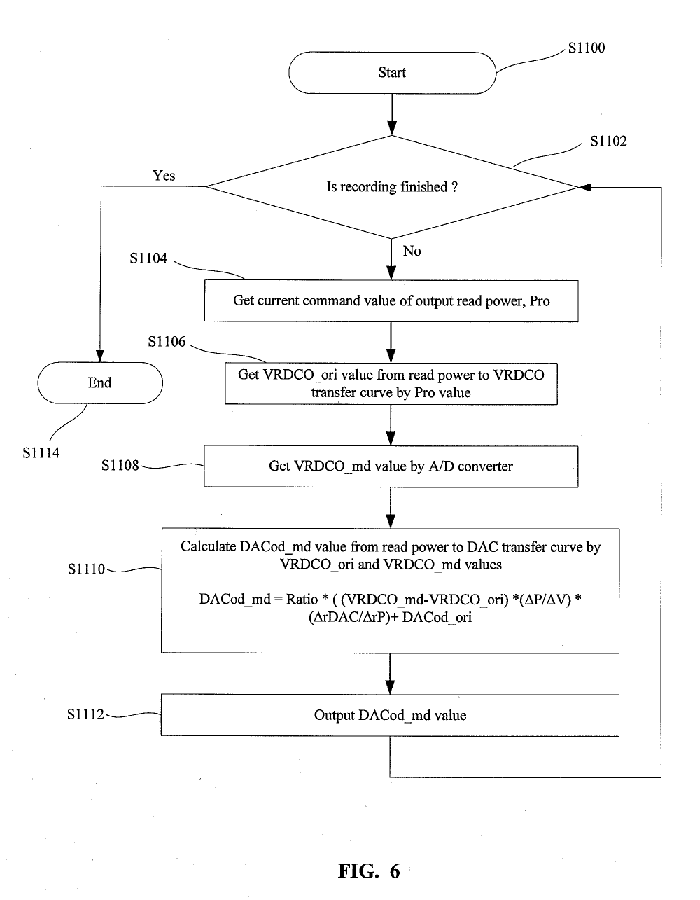

FIG. 6 illustrates a detailed embodiment of the present invention for exemplifying a method of calculating a new DACod value from the read power signal VRDCO and read power values. The method of calculating the new DACod value comprises the steps of:
Step S1100 Start;
Step S1102 Determining whether the recording procedure is finished, if the recording procedure is finished, go to step S1114, otherwise go to step S1104;
Step S1104 Getting a current command value of output read power Pro;
Step S1106 Calculating an orginal VRDCO value VRDCO_ori from read power to VRDCO transfer curve by Pro value;
Step S1108 The analog to digital converter gets a modified VRDCO value VRDCO_md;
Step S1110 Calculating a new DACod value DACod_md from read power to DAC transfer curve by VRDCO_ori and VRDCO_md values. The relationship of read power to DAC transfer curve is shown as equation (9):

$$DACod\_md = Ratio \times ( VRDCO\_md - VRDCO\_ori ) \times \frac{Δ P}{Δ V} \times \frac{Δ rDAC}{Δ rP} + DACod\_ori \qquad ( 9 )$$

Step S1112 Outputting the new DACod value DACod_md, and back to step S1102;
Step S114 End.

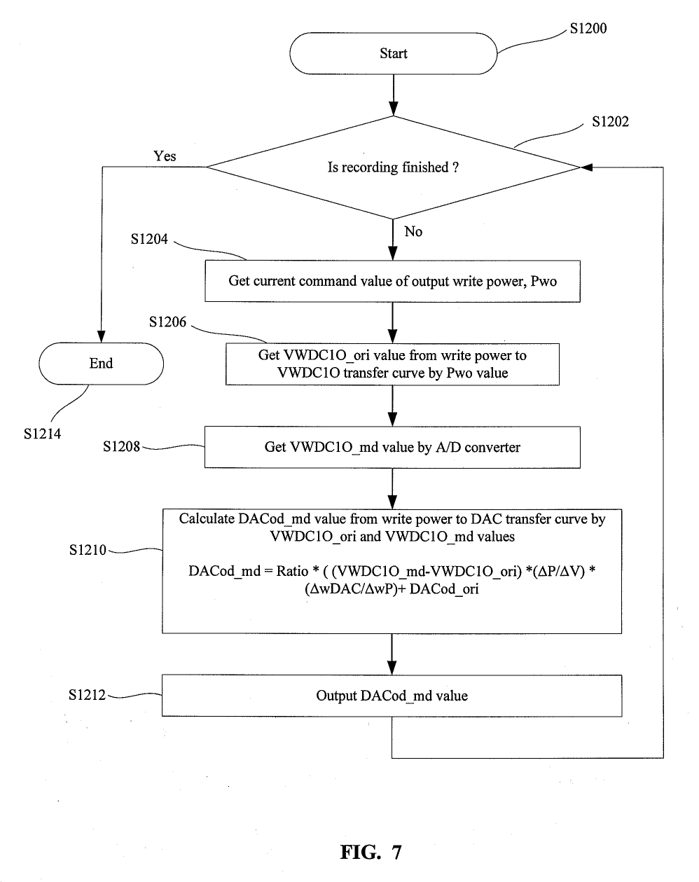

FIG. 7 illustrates another detailed embodiment of the present invention for exemplifying a method of calculating a new DACod value from the write power signal VWDC1O and write power values. The method of calculating the new DACod value comprises the steps of:
Step S1200 Start;
Step S1202 Determining whether the recording procedure is finished, if the recording procedure is finished, go to step S1214, otherwise go to step S1204;
Step S1204 Getting a current command value of output write power Pwo;
Step S1206 Calculating an original VWDC1O value VWDC1O_ori from write power to VWDC1O transfer curve by Pwo value;
Step S1208 The analog to digital converter gets a modified VWDC1O value VWDC1O_md;
Step S1210 Calculating a new DACod value DACod_md from write power to DAC transfer curve by VWDC1O_normal and VWDC1O_real values. The relationship of write power to DAC transfer curve is shown as equation (10):

$$DACod\_md = Ratio \times ( VWDC1O\_md - VWDC1O\_ori ) \times \frac{Δ P}{Δ V} \times \frac{Δ wDAC}{Δ wP} + DACod\_ori \qquad ( 10 )$$

Step S1212 Outputting the new DACod value DACod_md, and back to step S1202;
Step S1214 End.

It is noted that equation (9) or (10) is set to approach the required DAC curve. The power signals can be read or write power signals. The term ΔDAC/ΔP can utilize the read power related value (equation (1)) or the write power related value (equation (3)). Furthermore, the terms ΔP/ΔV and ΔDAC/ΔP may even incorporated into the term “Ratio” in some circumstances.

By utilizing the method of the present invention, an optimized write power of the laser emitting unit of the optical disk drive can be determined by introducing the current reading or write power signals of the laser emitting unit with a predetermined relationship of the output power of the laser emitting unit relative to the DAC value.

The advantages of the present invention include: (a) generating a modified DAC signal to adjust the output power of the laser emitting of an optical disk drive, especially to adjust a write power of the laser emitting, so that the write power is maintained in a constant level; (b) providing a high recording performance of the optical disk drive with a reduced cost by compensating the power variation due to the temperature variation without a high-speed APC circuit.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A power control system of an optical disk drive, said optical disk drive including a laser diode for generating laser of multiple power levels and a detecting unit for detecting laser powers to generate power feedback signals correspondingly, said system comprising:
a first power control unit generating an original first power control signal to control the laser diode to emit laser, receiving a first power feedback signal from the defecting unit, said first power feedback signal corresponding to the power level of the laser generated corresponding to the original first power control signal, said first power control unit generating a modified first power control signal according to the original power feedback signal and a desired power level to control the laser diode to emit laser corresponding to the modified first power control signal; and
a second power control unit receiving the original and modified first power control signals from the first power control unit, and generating a modified second power control signal according to a predetermined ratio, the modified and original first power control signals, and an original second power control signal to control the laser diode to emit laser with a desired power level.

2. The power control system of claim 1, wherein the first power control unit is selected from the group consisted of a read power control unit and a write power control unit.

3. The power control system of claim 1, wherein the second power control unit is selected from the group consisted of an over drive power control unit and a multipulse write power control unit.

4. The power control system of claim 1, wherein the first power control unit further comprises a sample and hold device to sample and hold the power feedback signal corresponding to the power level of the laser.

5. The power control system of claim 1, wherein the second power control unit generates the modified second power control signal by the formula:
$$DACod\_md = Ratio \times ( VLDCO\_md - VLDCO\_ori ) \times \frac{Δ P}{Δ V} \times \frac{Δ DAC}{Δ P} + DACod\_ori$$
wherein the DACod_md is the modified second power control signal, the Ratio is a predetermined value, the VLDCO_md is the modified first power control signal, the VLDCO_ori is the original first power control signal, ΔP/ΔV is a variation parameter of power to voltage, ΔDAC/ΔP is a value of DAC variation to power variation and the DACod_ori is the original second power control signal.

6. A power control method of an optical disk drive, said optical disk drive including a laser diode for generating laser of multiple power levels and a detecting unit for detecting laser powers to generate power feedback signals correspondingly, said method comprising steps of:
generating an original first power control signal to control the laser diode to emit laser;
generating a first power feedback signal corresponding to the laser generated corresponding to the original first power control signal;
generating a modified first power control signal according to the first power feedback signal and a desired power level to control the laser diode to emit laser corresponding to the modified first power control signal; and
generating a modified second power control signal according to a predetermined ratio, the modified and original first power control signals, and an original second power control signal to control the laser diode to emit laser with a desired power level.

7. The power control method of claim 6, wherein the first power control signal is selected one from the group consisted of a read power control signal and a write power control signal.

8. The power control method of claim 6, wherein the second power control signal is selected form the group consisted of the over drive power control signal and a multipulse power control signal.

9. The power control method of claim 6, further comprising sampling the first feedback signal corresponding to the power level of the laser.

10. The power control method of claim 6, wherein the modified second power control signal is generated by the formula:
$$DACod\_md = Ratio \times ( VLDCO\_md - VLDCO\_ori ) \times \frac{Δ P}{Δ V} \times \frac{Δ DAC}{Δ P} + DACod\_ori$$
wherein the DACod_md is the modified second power control signal, the Ratio is a predetermined value, the VLDCO_md is the modified first power control signal, the VLDCO_ori is the original first power control signal, ΔP/ΔV is a variation parameter of power to voltage, ΔDAC/ΔP is a value of DAC variation to power variation and the DACod_ori is the original second power control signal.
